(19) United States
(12) Patent Application Publication
(10) Pub. No.: US 2013/0272756 A1
(43) Pub. Date: Oct. 17, 2013

(54) FIXING APPARATUS

(71) Applicant: CANON KABUSHIKI KAISHA, Tokyo (JP)

(72) Inventors: Teppei Nagata, Abiko-shi (JP); Shigeaki Takada, Abiko-shi (JP); Osamu Sugino, Abiko-shi (JP)

(73) Assignee: CANON KABUSHIKI KAISHA, Tokyo (JP)

(21) Appl. No.: 13/800,849

(22) Filed: Mar. 13, 2013

(30) Foreign Application Priority Data
Apr. 13, 2012 (JP) 2012-091974

(51) Int. Cl. G03G 15/20

(52) U.S. Cl. CPC G03G 15/2085
USPC 399/323; 399/329

(57) ABSTRACT

A fixing apparatus includes a fixing belt configured to fix a toner image on a sheet at a nip portion, a rotating member configured to convey the sheet cooperatively with the fixing belt at the nip portion, a supporting roller configured to rotatably support the fixing belt and to press the fixing belt toward the rotating member, a separation pad provided in a position which is downstream of the supporting roller in a sheet conveyance direction and configured to press the fixing belt toward the rotating member to separate the sheet from the fixing belt, a holder configured to hold the separation pad, the holder being swingable around a center which is further away from the rotating member than the nip portion and which is downstream of the supporting roller, and an urging member configured to urge the holder in a rotational direction of the fixing belt.

### BACKGROUND OF THE INVENTION

1. Field of the Invention

The present invention relates to a fixing apparatus that fixes a toner image on a sheet. The fixing apparatus can be used for an image forming apparatus such as a copying machine, a printer, a facsimile (FAX) machine, or a multifunction peripheral having multiple functions of such devices.

2. Description of the Related Art

Japanese Patent Application Laid-Open No. 2007-121363 discusses a fixing apparatus that fixes a toner image formed on a sheet, using a fixing belt and a pressure roller. Particularly, a fixing roller, which rotatably supports a fixing belt, and a pressure roller nip the fixing belt to form a nip portion.

Then, a separation pad is mounted on the exit side of the nip portion to press the fixing belt toward the pressure roller from the inside of the fixing belt. As a result, the separation pad significantly changes the path of the fixing belt on the exit side of the nip portion. This enables the separation of a sheet from the fixing belt.

In the fixing apparatus, however, described in Japanese Patent Application Laid-Open No. 2007-121363, the separation pad is swingable around the center of rotational movement of the fixing roller. Further, the separation pad is urged in the direction opposite to the rotational direction of the fixing belt (see FIG. 3 of Japanese Patent Application Laid-Open No. 2007-121363).

That is, the fixing apparatus described in Japanese Patent Application Laid-Open No. 2007-121363 has a structure where the rotation of the fixing belt subjects the separation pad to a force in a direction away from the pressure roller. This is likely to lead to insufficient pressing of the separation pad. Thus, the sheet may not properly separate from the fixing belt.

### SUMMARY OF THE INVENTION

The present invention is directed to a fixing apparatus capable of preventing insufficient pressing of a separation pad.

The present invention is also directed to a fixing apparatus capable of properly separating a sheet from a fixing belt, using a separation pad.

According to an aspect of the present invention, a fixing apparatus includes a fixing belt configured to fix a toner image on a sheet at a nip portion, a rotating member configured to convey the sheet cooperatively with the fixing belt at the nip portion, a supporting roller configured to rotatably support the fixing belt and to press the fixing belt toward the rotating member, a separation pad provided in a position which is downstream of the supporting roller in a sheet conveyance direction and configured to press the fixing belt toward the rotating member to separate the sheet from the fixing belt, a holder configured to hold the separation pad, the holder being swingable around a center which is further away from the rotating member than the nip portion and which is downstream of the supporting roller, and an urging member configured to urge the holder in a rotational direction of the fixing belt.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating the configuration of an image forming apparatus.

FIG. 2 is a diagram illustrating the configuration of a fixing apparatus.

FIG. 3A is a diagram illustrating the configuration of a fixing apparatus according to a comparative example, and FIG. 3B is an enlarged view of a nip portion.

FIG. 4 is a diagram illustrating the pressure distribution of the conveyance direction of the nip portion according to the comparative example.

FIG. 5 is a diagram illustrating an uneven gloss.

FIG. 6A is a diagram illustrating the configuration of a fixing apparatus according to a first exemplary embodiment, and FIG. 6B is an enlarged view of a nip portion.

FIG. 7 is a diagram illustrating a mechanism for adjusting the position of a separation pad.

FIG. 8 is a diagram illustrating the pressure distribution of a nip portion according to the first exemplary embodiment.

FIG. 9 is a diagram illustrating the range of location of a swinging shaft.

FIG. 10 is a diagram illustrating the configuration of a fixing apparatus according to a third exemplary embodiment.

FIG. 11 is a diagram illustrating the configuration of a fixing apparatus according to a fourth exemplary embodiment.

### DESCRIPTION OF THE EMBODIMENTS

Various exemplary embodiments, features, and aspects of the invention will be described in detail below with reference to the drawings.

In exemplary embodiments of the present invention, various configurations can be replaced by other known configurations within the scope of the idea of the present invention, unless otherwise stated.

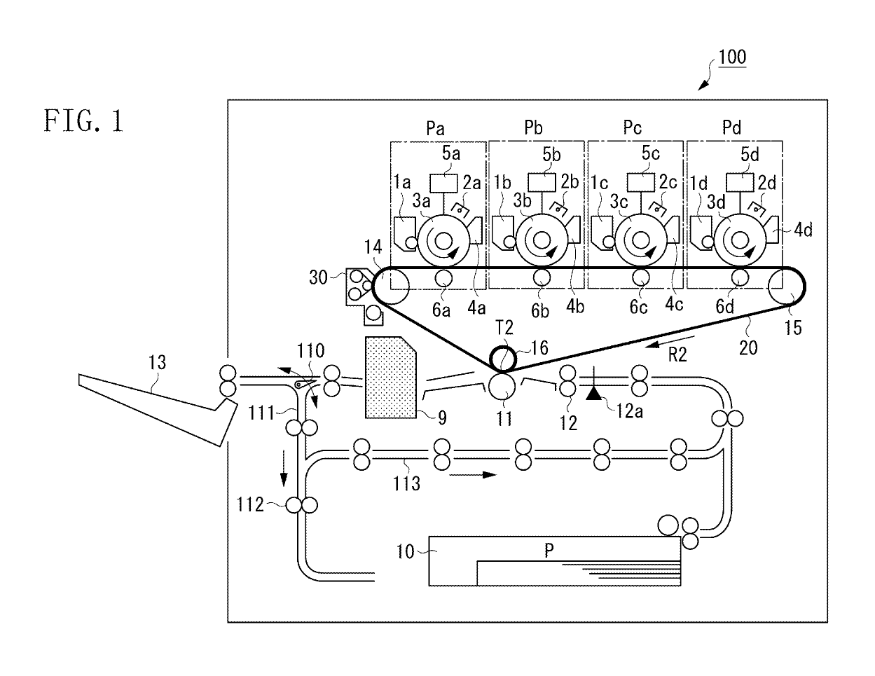

FIG. 1 is a diagram illustrating the configuration of an image forming apparatus. As illustrated in FIG. 1, an image forming apparatus 100 is a full-color printer of the tandem intermediate transfer type, in which image forming units Pa, Pb, Pc, and Pd (yellow, magenta, cyan, and black, respectively) are arranged along an intermediate transfer belt 20. It should be noted that not only a printer but also a copying machine, a FAX, or a multifunction peripheral having multiple functions of such devices is similarly applicable to the image forming apparatus.

The image forming unit Pa forms a yellow toner image on a photosensitive drum 3a, and primarily transfers the yellow toner image onto the intermediate transfer belt 20. The image forming unit Pb forms a magenta toner image on a photosensitive drum 3b, and primarily transfers the magenta toner image onto the intermediate transfer belt 20. The image forming units Pc and Pd form a cyan toner image and a black toner image on photosensitive drums 3c and 3d, respectively, and sequentially primarily transfer the cyan toner image and the black toner image onto the intermediate transfer belt 20.

Sheets (recording materials) P are taken out of a cassette 10 one by one, and each sheet P stands by at a registration roller 12. The sheet P is fed to a secondary transfer portion T2 by the registration roller 12 in timing with a toner image on the intermediate transfer belt 20, and the toner image is secondarily transferred from the intermediate transfer belt 20 onto the sheet P. The sheet P onto which the toner image of four colors has been secondarily transferred is conveyed to a fixing apparatus 9. The sheet P is heated and pressed by the fixing apparatus 9 to fix the toner image onto the sheet P, and is thereafter discharged to a tray 13 outside the image forming apparatus 100.

In two-sided printing, a sheet having an image fixed on its front surface by the fixing apparatus 9 is fed to a reverse conveyance path 111 by a direction switching device 110. The sheet is switched back by a conveyance roller 112 and fed to a reverse conveyance path 113. The sheet, back to front and face down, stands by at the registration roller 12. The sheet is fed to the secondary transfer portion T2 in timing with a toner image on the intermediate transfer belt 20, which is an image for the back surface of the sheet, and the toner image is transferred onto the back surface. After the image on the back surface is fixed onto the sheet by the fixing apparatus 9, the sheet is discharged to the tray 13 outside the image forming apparatus 100.

The image forming units Pa, Pb, Pc, and Pd are configured substantially similarly to each other, except that the colors of the toners used in developing devices 1a, 1b, 1c, and 1d are different, namely yellow, magenta, cyan, and black, respectively. In the following, the yellow image forming unit Pa is described, and redundant description of the other image forming units Pb, Pc, and Pd is omitted.

In the image forming unit Pa, a corona charger 2a, an exposure device 5a, the developing device 1a, a primary transfer roller 6a, and a drum cleaning device 4a are placed around the photosensitive drum 3a.

The corona charger 2a charges the surface of the photosensitive drum 3a rotating at a process speed of from 300 mm/sec to 500 mm/sec to a uniform potential. The exposure device 5a scans a laser beam to write an electrostatic image of an image onto the photosensitive drum 3a. The developing device 1a develops the electrostatic image to develop a toner image on the photosensitive drum 3a. When a voltage has been applied to the primary transfer roller 6a, the primary transfer roller 6a primarily transfers the toner image on the photosensitive drum 3a onto the intermediate transfer belt 20.

The intermediate transfer belt 20 is supported by the intermediate transfer belt 20 stretched around a tension roller 14, a driving roller 15, and an opposing roller 16, and is driven by the driving roller 15 to rotate in the direction of an arrow R2. A secondary transfer roller 11 comes into pressure contact with the intermediate transfer belt 20 supported by the opposing roller 16, thereby forming the secondary transfer portion T2. A belt cleaning device 30 rubs a cleaning web against the intermediate transfer belt 20 to clean transfer residual toner having passed through the secondary transfer portion T2.

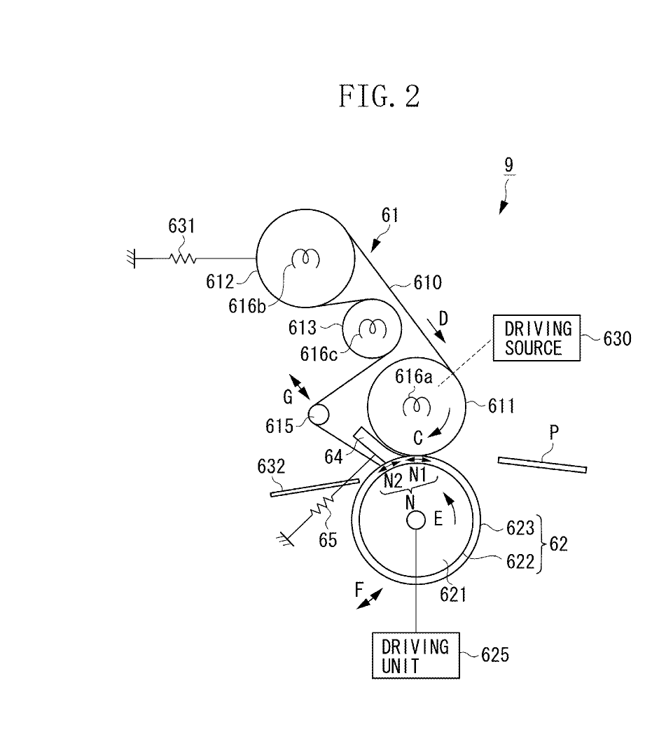

FIG. 2 is a diagram illustrating the configuration of the fixing apparatus 9. As illustrated in FIG. 2, when the fixing apparatus 9 performs a fixing process, a fixing roller (supporting roller) 611 is subjected to a driving force from a driving source 630 to start rotating in the direction of an arrow C, with a pressure roller 62 being separated from a fixing belt module 61. With the rotation of the fixing roller 611, a fixing belt (endless belt) 610 is driven by the fixing roller 611 to start rotating in the direction of an arrow D.

Subsequently, the pressure roller 62 is moved by a driving unit 625, which is a moving mechanism, to such a position that the pressure roller 62 comes into pressure contact with the fixing belt 610, thereby forming a nip portion N (an area where the fixing belt 610 and the pressure roller 62 nip and convey a sheet to perform the fixing process) between the fixing belt 610 and the pressure roller 62. Thereafter, a sheet P onto which a toner image has been transferred is fed to the nip portion N, and the toner image is fixed onto the sheet P.

Having entered the nip portion N, the sheet P is nipped and conveyed downstream in a sheet conveyance direction by the fixing belt 610 and the pressure roller 62, which are rotating. Then, the sheet P passes first through a roller nip portion N1 (a nip portion formed between the fixing roller 611 and the pressure roller 62) and then through a separation pad nip portion N2 (a nip portion formed between a separation pad 64 and the pressure roller 62). In the process of passing through the roller nip portion N1 and the separation pad nip portion N2, the sheet P is pressed and heated by the fixing belt 610 and the pressure roller 62. This results in fusing the toner image and fixing the toner image onto the sheet P.

After having passed through the separation pad nip portion N2, the fixing belt 610 moves following a side surface of the separation pad 64. This sharply changes, at the exit of the nip portion N, the moving direction (path) of the fixing belt 610 to bend in the direction of an idler roller 615. Thus, the sheet P cannot follow the change in the moving direction of the fixing belt 610 after exiting the separation pad nip portion N2. This curvature-separates the sheet P from the fixing belt 610 by the stiffness (firmness) of the sheet P itself at the exit of the nip portion N. The sheet P thus stably separates from the fixing belt 610.

It should be noted that the moving direction of the sheet P having separated from the fixing belt 610 is guided by a separation guide 632 disposed downstream of the nip portion N. After the fixing process on the sheet P is completed, the pressure roller 62 moves away from the fixing belt module 61 by the driving unit 625, and returns to the original standby position, which is separate from the fixing belt module 61.

The main portion of the fixing apparatus 9 includes the fixing belt module 61 and the pressure roller 62 placed in pressure contact with the fixing belt module 61. In the fixing belt module 61, the endless fixing belt 610 is rotatably provided.

The fixing belt 610 is a flexible endless belt. In the fixing belt 610, an elastic layer made of silicone rubber and having a thickness of 400 μm is laminated to the surface side (the outer peripheral surface side) of a base layer formed of a polyimide resin layer or a nickel metal layer and having a thickness of 100 μm. The elastic layer is coated with a release layer made of a tetrafluoroethylene-perfluoroalkyl vinyl ether copolymer resin (PFA) tube and having a thickness of 40 μm.

The fixing roller 611 is rotatably disposed inside the fixing belt 610. The fixing roller 611, having a diameter of 80 mm, is driven to rotate by the driving source 630 such as a motor. The fixing roller 611, not having an elastic layer formed on its peripheral surface, is a hard roller formed by coating the surface of an aluminum core metal (hollow cylinder) with a toner release layer (a heat-resistant fluororesin layer). The heat-resistant fluororesin is a tetrafluoroethylene-perfluoroalkyl vinyl ether copolymer (PFA). A halogen heater 616a is disposed within the fixing roller 611 and heats the fixing roller 611 from the inside.

An internal heating roller 612 doubles as a tension roller to stretch the fixing belt 610. The internal heating roller 612 is a cylindrical roller formed of aluminum. A halogen heater 616b, which is a heating mechanism, is provided within the internal heating roller 612 and heats the internal heating roller 612. Tension springs 631 are placed at both ends of the internal heating roller 612 and press the internal heating roller 612 toward the fixing belt 610 to impart a predetermined tension to the fixing belt 610.

An external heating roller 613 is a cylindrical roller formed of aluminum. The external heating roller 613 stretches the fixing belt 610 from the outside and also heats the fixing belt 610 from the outside. A halogen heater 616c, which is a heating mechanism, is disposed within the external heating roller 613 and heats the external heating roller 613.

The separation pad 64 is placed in a downstream area (an area closer to the exit) in the nip portion N (an area where the fixing belt 610 and the pressure roller 62 nip and convey a sheet) formed between the fixing belt 610 and the pressure roller 62, and is placed also near the fixing roller 611. As illustrated in FIG. 2, to enter and fit a wedge-shaped space surrounded by the fixing roller 611 and the fixing belt 610, the separation pad 64 is wedge-shaped on the fixing roller 611 side to follow the wedge-shaped space. Then, the separation pad 64 plays the role of facilitating the curvature separation of the sheet P from the fixing belt 610.

A spring member (urging member) 65 urges swinging members (a holder) 68, holding the separation pad 64, to rotationally move in the same direction as the rotational direction of the fixing belt 610. That is, the spring member 65 plays the role of pressing the separation pad 64 toward the fixing belt 610 so that the fixing belt 610 forms the part N2 of the nip portion N between the fixing belt 610 and the pressure roller 62. It should be noted that the idler roller 615 is provided downstream of the nip portion N to stretch the fixing belt 610.

The separation pad 64 is a non-rotational member and is placed in a position which is downstream of and near the roller nip portion N1 where the pressure roller 62 is in pressure contact with the fixing roller 611 through the fixing belt 610. The separation pad 64 is a plate-like member formed of a metal such as stainless or of a heat-resistant resin such as a liquid crystal polymer, and provided along the axial direction of the fixing roller 611. An axially perpendicular cross section of the separation pad 64 at its leading edge is formed in a generally arcuate shape adapted to the pressure roller 62. The separation pad 64 uniformly presses the pressure roller 62 across a predetermined width area with a predetermined load through the fixing belt 610, thereby forming the separation pad nip portion N2 downstream of the roller nip portion N1.

As a rotating member, the pressure roller 62 has a diameter of 100 mm and is installed to press the fixing belt module 61. The pressure roller 62 is driven by the rotation of the fixing belt 610 to rotate in the direction of an arrow E. The pressure roller 62 is a soft roller formed by laminating an elastic layer 622 and a toner release layer 623, in this order, to a roller (hollow cylinder) 621 as a base body. The pressure roller 62 is movable, by being driven by the driving unit 625 using a cam mechanism, in the direction of an arrow F, which is toward or away from the fixing belt module 61.

As illustrated in FIG. 2, the fixing-belt-type fixing apparatus 9 brings the pressure roller 62 into pressure contact with the fixing belt 610, using the fixing belt 610 on the side of contacting the toner image, thereby forming the nip portion N for the sheet P. The fixing-belt-type fixing apparatus 9 can secure the nip portion N longer in the sheet conveyance direction than that of a conventional roller fixing apparatus that brings a pressure roller into pressure contact with a fixing roller to form a nip portion. Thus, the fixing apparatus 9 can sufficiently heat the sheet P even when employed for a high-speed machine, which may be a desirable configuration.

Further, in the fixing apparatus 9 according to the present exemplary embodiment, even if the sheet fed to the nip portion N has rapidly removed heat from the fixing belt 610, the external heating roller 613 and the internal heating roller 612 supply heat to the fixing belt 610. This makes unlikely a fall in the surface temperature (temperature droop) of the fixing belt 610, which may be a desirable configuration.

Further, in the fixing apparatus 9 according to the present exemplary embodiment, the separation pad 64 is placed downstream of the roller nip portion N1 formed between the fixing roller 611 and the pressure roller 62, thereby forming the separation pad nip portion N2. Thus, the fixing apparatus 9 is configured to form a nip portion sufficiently long in the sheet conveyance direction, and also to press the fixing belt 610 from the inner surface of the fixing belt 610 toward the pressure roller 62 using the separation pad 64, thereby curvature-separating the sheet.

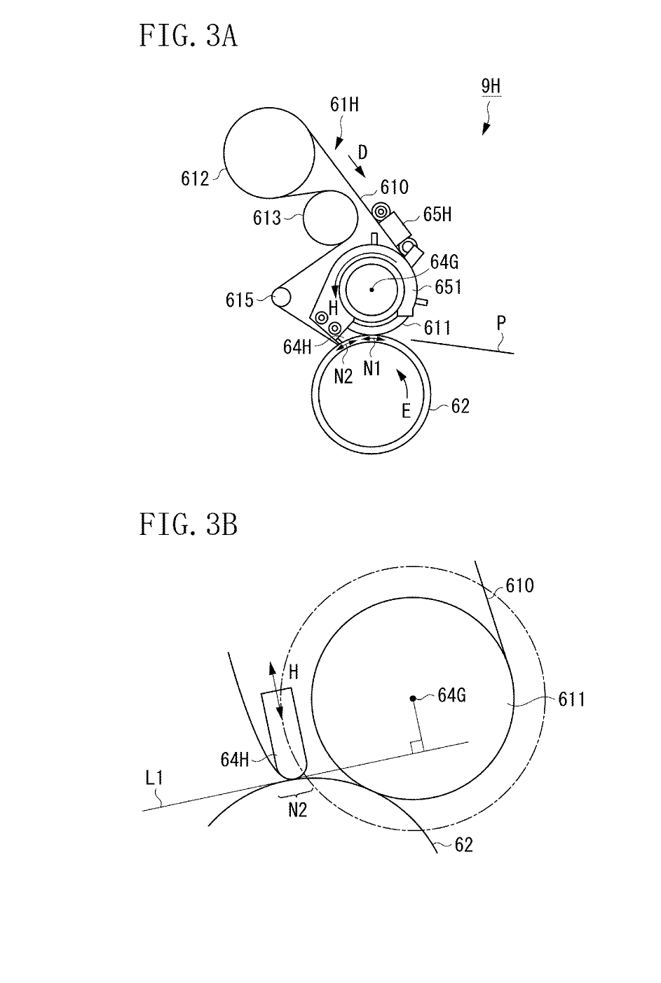

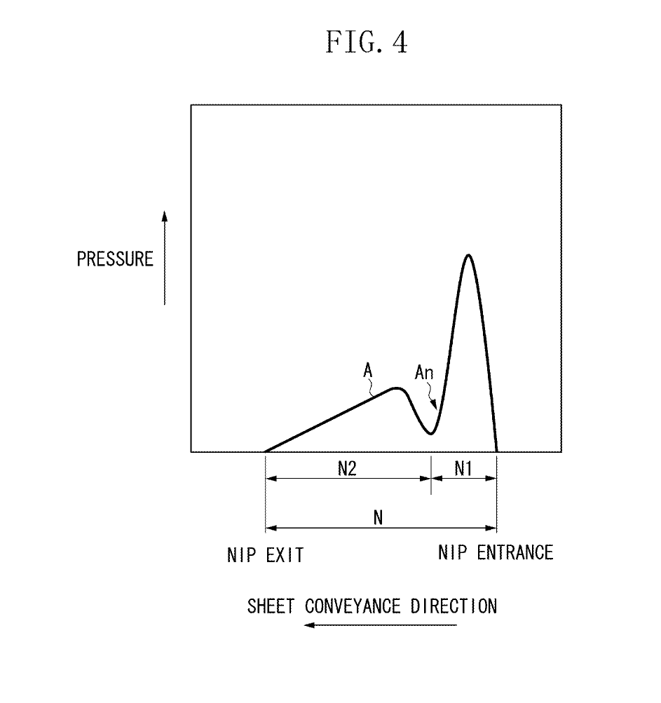

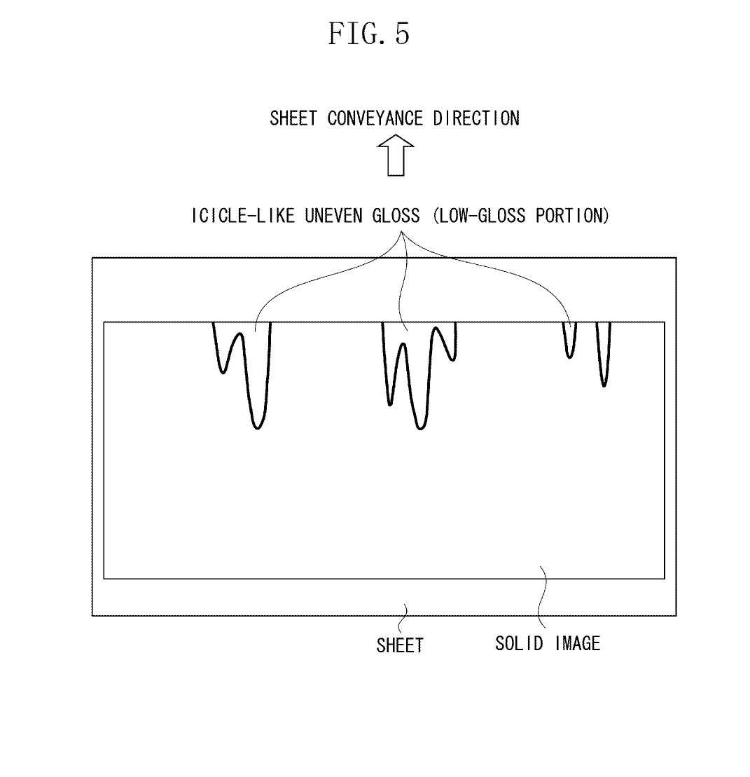

FIGS. 3A and 3B are diagrams illustrating the configuration of a fixing apparatus according to a comparative example. FIG. 4 is a diagram illustrating the pressure distribution of a nip portion in a conveyance direction according to the comparative example. FIG. 5 is a diagram illustrating an uneven gloss.

As illustrated in FIG. 3A, in a fixing apparatus 9H according to the comparative example, a separation pad 64H is attached rotatably around a fixing roller 611 so that the orientation of the separation pad 64H relative to the fixing roller 611 is maintained when the separation pad 64H moves around the fixing roller 611. In the fixing apparatus 9H, to form a nip portion N, the center of rotational movement of the separation pad 64H is provided on the rotational axis line of the fixing roller 611. Then, a rotational movement plate 651 to which the separation pad 64H is fixed is urged in the direction of an arrow H (the direction opposite to the rotational direction of a fixing belt 610), using a spring member 65H.

When a sheet P enters a separation pad nip portion N2, the spring member 65H, as illustrated in FIG. 3B, presses the separation pad 64H so as to be likely to escape in the direction of the arrow H. The pressing force of the separation pad nip portion N2 is smaller than that of a roller nip portion N1, which facilitates the escape of the pressing force of the separation pad 64H and, therefore, facilitates a decrease in the pressing force.

FIG. 4 illustrates the distribution of a pressure A of the nip portion N. As illustrated in FIG. 4, the resulting pressure distribution is not continuous in the sheet conveyance direction. This produces a large pressure reduction portion “An” between the roller nip portion N1 and the separation pad nip portion N2. In the pressure reduction portion “An”, the air expanded by heating and the water vapor generated from the sheet tend to prevent the toner image from coming into contact with the fixing belt 610. The nip pressure of the separation pad nip portion N2 is lower than the nip pressure of the roller nip portion N1. This makes it difficult for the separation pad nip portion N2 to suppress the water vapor generated in the pressure reduction portion “An”. There may be a wide non-pressure area where the nip pressure is almost 0 or a wide low-pressure area where the nip pressure is reduced, between the roller nip portion N1 and the separation pad nip portion N2.

When a solid image is formed on a sheet having a low air permeability, such as coated paper, the water vapor from the sheet having been suppressed in the roller nip portion N1 may be, as illustrated in FIG. 5, released without being blocked in the non-pressure area or the low-pressure area. Then, the water vapor moving around between the fixing belt 610 and the sheet P may disturb the toner image and cause defective fixing or image disturbance. Such a problem arises notably under a humid environment where air contains a large amount of moisture.

Further, the air present in an unfixed toner layer is likely to stagnate in the pressure reduction portion “An”, which is in the boundary region between the fixing roller 611 and the separation pad 64 and which has a low pressure. The air partially produces space at the interface between the sheet P and the fixing belt 610 and also disturbs a toner image that is not completely fixed.

These conditions may make a difference in glossiness on the surface of the image, between the portion of the sheet P that has been prevented from coming into contact with the fixing belt 610 and the portion of the sheet P that has not been prevented from coming into contact with the fixing belt 610. This may cause an uneven gloss on the image surface of the output image, or may produce an icicle-like low-gloss portion (a haze, hereinafter referred to as an “uneven gloss”) on a solid image.

It should be noted that if a sheet is plain paper, the sheet has a sufficient air permeability. This causes the air present in a toner layer to be retained within, or to pass through and escape from, paper fibers, which are porous bodies having large capacities. Thus, it is considered that image disturbance is unlikely to occur.

To deal with this situation, the following exemplary embodiments employ a mechanism for, when the sheet P enters the separation pad nip portion N2, pressing the separation pad 64 so as to be likely to bite into the pressure roller. Specifically, the following exemplary embodiments employ a mechanism for urging the separation pad 64 (the swinging members 68) in the rotational direction of the fixing belt 610.

Further, the separation pad 64 is provided in proximity to the roller nip portion N1, thereby reducing a non-pressure area and a low-pressure area. This stabilizes the positional relationship between the fixing roller and the separation pad to prevent the production of the pressure reduction portion “An” between the roller nip portion N1 and the separation pad nip portion N2. This suppresses the disturbance of a toner image caused by the generation of water vapor.

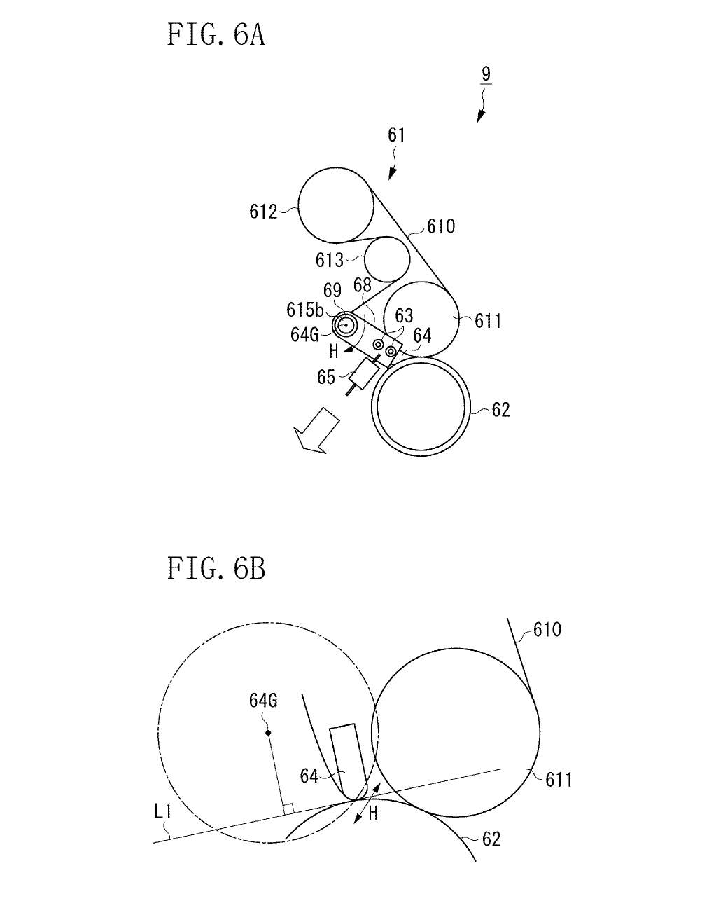

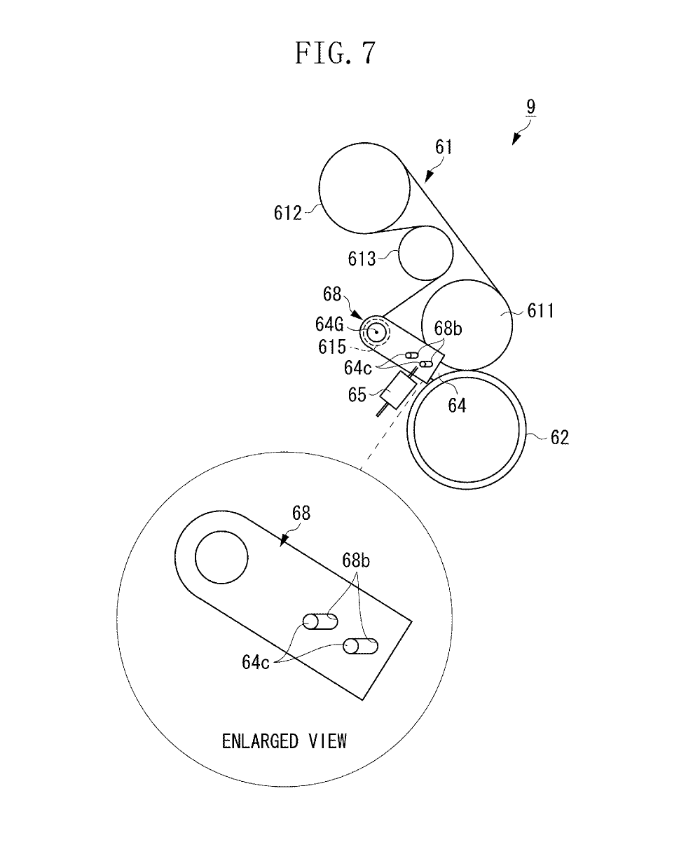

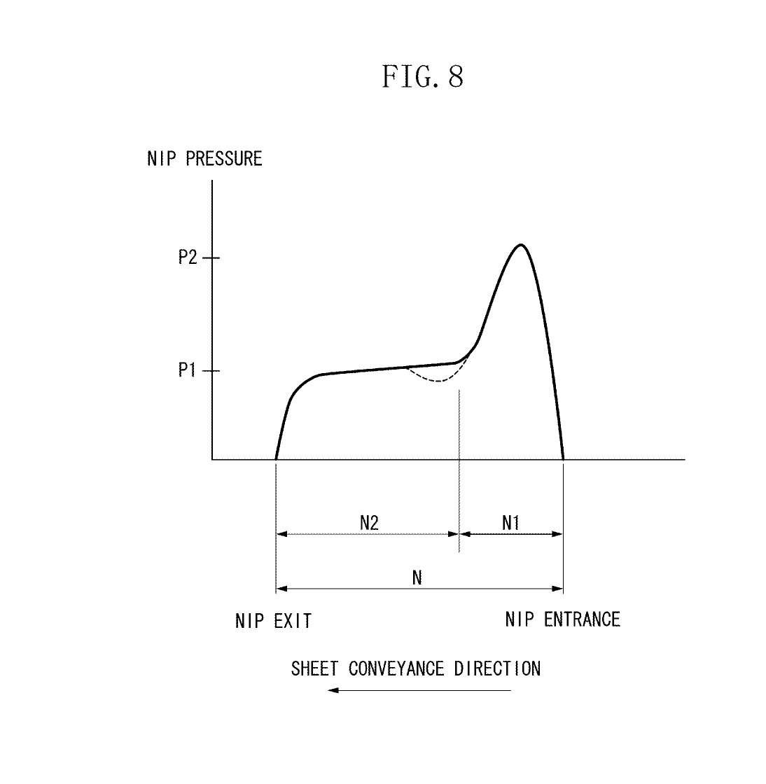

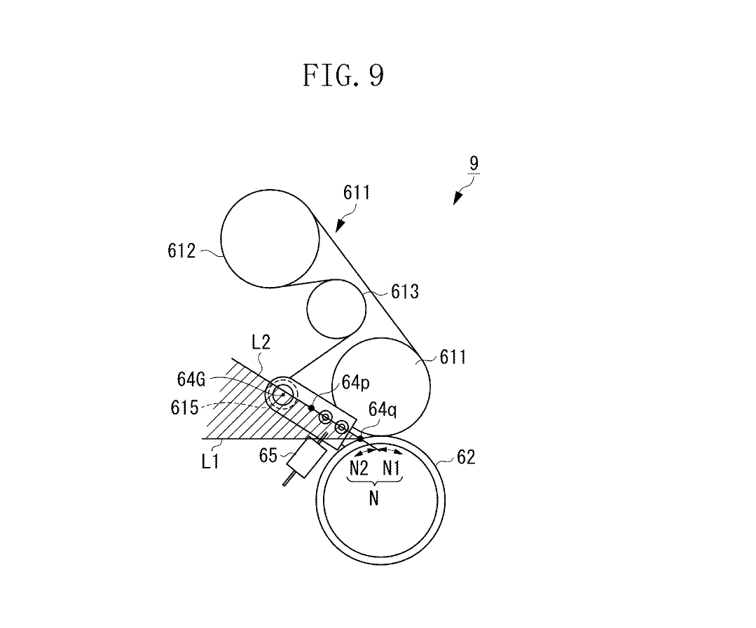

FIGS. 6A and 6B are diagrams illustrating the configuration of a fixing apparatus according to a first exemplary embodiment. FIG. 7 is a diagram illustrating a mechanism for adjusting the position of a separation pad. FIG. 8 is a diagram illustrating the pressure distribution of a nip portion according to the first exemplary embodiment. FIG. 9 is a diagram illustrating the range of location of a swinging shaft.

As illustrated in FIG. 6A, a fixing belt 610, which is an example of a belt member, rotates in contact with the image surface of a sheet. A fixing roller 611, which is an example of a supporting roller, rotates while supporting the inner surface of the fixing belt 610. It should be noted that the fixing roller 611 functions also as a driving roller for the fixing belt 610. A pressure roller 62, which is an example of a rotating member, comes into pressure contact with the fixing roller 611 through the fixing belt 610, thereby forming a nip portion N for a sheet P between the pressure roller 62 and the fixing belt 610. The pressure roller 62 has an elastic layer so that the peripheral surface of the pressure roller 62 is elastically deformable.

A separation pad 64, which is an example of a separation member, is placed downstream of the nip portion N and in contact with the inner surface of the fixing belt 610 and is placed also in pressure contact with the pressure roller 62 via the fixing belt 610. Further, the separation pad 64 sharply changes the path of the fixing belt 610 and guides the fixing belt 610 in a direction away from the pressure roller 62. A spring member 65, which is an example of an urging member, urges the separation pad 64 (swinging members 68) in the same direction as the rotational direction of the fixing belt 610. The curved surface of the fixing belt 610 pressed by the separation pad 64 presses and elastically deforms the peripheral surface of the pressure roller 62. A stretching roller 615 is provided downstream of the nip portion N to stretch the fixing belt 610, thereby forming a space where the separation pad 64 is swingable (see FIG. 2). The surface of the separation pad 64 that slides in contact with the fixing belt 610 has a curved shape having a radius of curvature equal to or greater than that of the pressure roller 62 in the position where the separation pad 64 is in pressure contact with the fixing belt 610.

The swinging members (holder) 68 hold the separation pad 64 and are also swingably supported by a swinging shaft. Further, the separation pad 64 is attached to the swinging members 68 such that the gap between the separation pad 64 and the fixing roller 611 can be adjusted. The swinging shaft of the swinging members 68 is placed further away from the pressure roller 62 than the fixing belt 610 so that the swinging shaft swingably supports the swinging members 68 to which the separation pad 64 is attached. Further, the swinging shaft swingably supports the swinging members 68 so that the separation pad 64 presses the pressure roller 62 when the fixing belt 610 rotates. It should be noted that the swinging shaft of the swinging members 68 is placed coaxially with the rotational axis of the stretching roller 615.

A swinging center 64G of the swinging members 68 is, as illustrated in FIGS. 6A and 6B, placed further away from the pressure roller 62 than the nip portion N formed between the fixing belt 610 and the pressure roller 62, and is placed also in a position which is downstream of the fixing roller 611 in the sheet conveyance direction. Thus, the position where the separation pad 64 abuts the fixing belt 610 is placed closer to the fixing roller 611 than a straight line which is perpendicular to the tangent line of the pressure roller 62 passing through the position where the separation pad 64 is in pressure contact with the fixing belt 610, and which passes through the center 64G of the swinging shaft of the swinging members 68. In other words, the structure is such that the force of the separation pad 64 pressing the fixing belt 610 when the fixing belt 610 rotates is naturally greater than that when the fixing belt 610 stops.

On the side surfaces of the fixing apparatus 9, bearings 69 are provided in the outer periphery of a supporting portion 615b of an idler roller 615. The pair of swinging members 68 are swingably attached, through the respective bearings 69, to a shaft portion of the idler roller 615 at both ends in the longitudinal direction. The pair of swinging members 68 is connected to both ends of the separation pad 64. In each swinging member 68, a fitting portion is formed so that the swinging member 68 is placed swingably around the central axis of the idler roller 615 by locking the fitting portion with the outer peripheral portion of the bearing 69.

The spring member 65 urges the swinging members so that the separation pad 64 presses the pressure roller 62 through the fixing belt 610. One end of the spring member 65 is fixed to the swinging members 68, and the other end is fixed to a body frame of the fixing apparatus 9. The spring member 65 is a tension coil spring that urges the swinging members 68 downward with respect to the tangent line of a separation pad nip portion N2. The swinging members 68 double as spring receiving members that receive the spring member 65. The urging force produced by the spring member 65 is transmitted to the swinging members 68. Holding the separation pad 64, the swinging members 68 ultimately transmits the urging force of the spring member 65 to the separation pad 64. An appropriate change in the spring constant of the spring member 65 enables the spring member 65 to adjust the pressing force to be imparted to the separation pad 64 through the swinging members 68.

As illustrated in FIG. 7, elongated holes 68b, which function as an adjustment mechanism, are obliquely formed in the swinging members 68. Particularly, in each swinging member 68, two elongated holes 68b are formed through the swinging member 68 in the axial direction of the idler roller 615. The separation pad 64 is placed along the axial direction of the fixing roller 611 with an approximately constant gap between the separation pad 64 and the fixing roller 611. The elongated holes 68b extend in the direction in which the separation pad 64 moves toward or away from the fixing roller 611. Thus, the positions where the separation pad 64 should be fixed (round holes 64c through which screw members 63 are inserted) are adjusted along the elongated holes 68b. This enables the adjustment of the position of the separation pad 64 relative to the fixing roller 611 (the gap between the separation pad 64 and the fixing roller 611).

The screw members (fastening members) 63, which function as an adjustment mechanism, are inserted through and fastened to the elongated holes 68b of the swinging members 68 and the round holes 64c of the separation pad 64, thereby fixing the separation pad 64 to the swinging member 68.

In the adjustment step, the screw members 63 are once loosened, the position of the separation pad 64 is adjusted in a direction toward or away from the fixing roller 611, the screw members 63 are inserted through the elongated holes 68b, and the screw members 63 are screwed into the screw round holes 64c (FIG. 7) formed in the body of the separation pad 64. This results in integrating the swinging members 68 and the separation pad 64 together, with the position of the separation pad 64 adjusted relative to the fixing roller 611.

As illustrated in FIG. 6B, the rotation of the fixing belt 610 causes the separation pad 64 to rotationally move slightly downstream in the sheet conveyance direction by sliding in contact with the fixing belt 610. This results in a relationship where the separation pad 64 bites further into the fixing belt 610 (the pressure roller 62). That is, the rotational movement of the separation pad 64 (the swinging members 68) in the direction of an arrow H causes the separation pad 64 to move in the direction in which the separation pad 64 bites into the pressure roller 62. This provides an advantageous structure where the pressing force of the separation pad 64 against the pressure roller 62 may increase, but not decrease, with the rotation of the fixing belt 610.

As described above, in the present exemplary embodiment, the separation pad 64 is provided so as to be likely to bite into the pressure roller 62. Thus, the structure of the present exemplary embodiment is advantageous over that of the comparative example where the separation pad 64 is provided so as to be likely to escape from the pressure roller 62 (FIGS. 3A and 3B). This enables the separation pad 64 to impart a stable pressing force to the fixing belt 610. In the separation pad 64 according to the first exemplary embodiment, the pressure of the separation pad nip portion N2 is more stable than that of the separation pad 64H according to the comparative example (FIGS. 3A and 3B). This makes the position of the separation pad 64 unlikely to change. This enables the suppression of image disturbance due to the expansion of air and the generation of water vapor in the nip portion N, without forming a pressure reduction portion (An: FIG. 4) in the boundary region between the separation pad 64 and the fixing roller 611.

As illustrated in FIGS. 3A and 3B, when the pressure roller 62 is lifted up from the separate state to press the fixing belt 610, the separation pad 64 is pressed toward the pressure roller 62 through the fixing belt 610, and the fixing belt 610 comes in pressure contact with the pressure roller 62 with no space between the fixing belt 610 and the pressure roller 62. At this time, the pressure contact of the fixing roller 611 forms the roller nip portion N1, and the pressure contact of the separation pad 64 forms the separation pad nip portion N2.

As illustrated in FIG. 8, the peak pressure of the separation pad nip portion N2 is set to be lower than the peak pressure of the roller nip portion N1. FIG. 8 illustrates the pressure distribution from the entrance to the exit of the nip portion N of the fixing apparatus 9. The horizontal axis represents the position in the conveyance direction, and the vertical axis represents the pressure level.

In the first exemplary embodiment, from the entrance to the exit of the nip portion N, a pressure distribution is obtained that almost continuously rises and falls without forming a serious pressure reduction portion from a high pressure P2 (0.05 MPa to 0.2 MPa) to a low pressure P1 (0.3 MPa to 0.5 MPa). In practice, a slight reduction in pressure occurs as indicated by a dashed line. In the first exemplary embodiment, a serious pressure reduction portion is not formed in the middle of the nip portion N. Thus, an image deviation and an uneven gloss are unlikely to occur.

Further, in the first exemplary embodiment, the swinging center 64G of the swinging members 68 and the central axis of the idler roller 615 coincide with each other. The swinging center 64G of the swinging members 68, however, is not limited to this, and may be located in the following area. Specifically, the swinging center 64G may be located in the range surrounded by: the tangent line of the roller nip portion N1 (the nip portion formed between the fixing roller 611 and the pressure roller 62), and a line perpendicular to the tangent line of the separation pad nip portion N2 (the nip portion formed between the separation pad 64 and the pressure roller 62), and located also in a hatched area which is downstream in the sheet conveyance direction.

Desirably, as illustrated in FIG. 9, the swinging center 64G of the swinging members 68 may be located in the range (a hatched area including the lines indicating the range) surrounded by a tangent line L1 of the roller nip portion N1, and a line L2 connecting a center of gravity 64p of the swinging members 68, holding the separation pad 64, and a point 64q which is the center, in the sheet conveyance direction, of the area where the separation pad 64 is in contact with the fixing belt 610.

In the fixing apparatus according to the first exemplary embodiment, the center of rotational movement of the separation pad 64 is provided in such a position that the separation pad 64 is pressed so as to be likely to bite into the roller. This prevents the pad pressure from escaping during the formation of the nip portion N. The center of the swinging shaft of the swinging members 68 is provided in such a position that the swinging members 68 are pressed so as to be likely to bite into the pressure roller 62. This stabilizes the positional relationship between the pressure roller 62 and the separation pad 64. This enables the suppression of an image defect and also enables the reduction of a pressure void in the nip portion N.

The fixing apparatus according to the first exemplary embodiment can prevent an image defect that occurs due to the production of a pressure void portion, with a simple structure. This facilitates downsizing a fixing apparatus and reducing the cost of a fixing apparatus.

As illustrated in FIG. 8, in the first exemplary embodiment, the pressure of the roller nip portion N1 is higher than the pressure of the separation pad nip portion N2. In contrast, in a second exemplary embodiment, the spring constant of the spring member 65 is higher than that of the first exemplary embodiment. Thus, the pressure of the roller nip portion N1 is lower than the pressure of the separation pad nip portion N2. The other components of the second exemplary embodiment are similar to those of the first exemplary embodiment, and, therefore, are not described.

A toner image on a sheet is heated from the entrance of the nip portion and reaches the maximum temperature in a position near the exit of the nip portion. Then, the application of high pressure to the sheet with the toner sufficiently fused is an efficient pressurization method for improving the fixability of the toner. Further, the pressure P2 (about 0.2 MPa) of the separation pad nip portion N2 is a pressure required to separate the sheet P from the fixing roller 611. The pressure P2 partially deforms the elastic layer of the fixing belt 610 to efficiently separate the sheet P stuck to the fixing belt 610.

Thus, in the second exemplary embodiment, the peak pressure of the separation pad nip portion N2 is set to be higher than the peak pressure of the roller nip portion N1. The fixing nip N in which a low-pressure portion on the entrance side and a high-pressure portion on the exit side are adjacent to each other provides desired performances of fixing and separation.

Also the second exemplary embodiment having such a configuration can produce effects similar to those of the first exemplary embodiment.

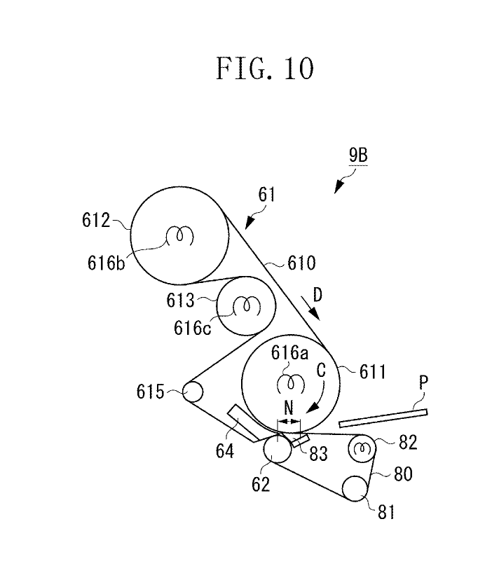

FIG. 10 is a diagram illustrating the configuration of a fixing apparatus according to a third exemplary embodiment. The example of the first exemplary embodiment uses the pressure roller as the rotating member that forms the nip portion between the rotating member and the fixing belt. In contrast, the third exemplary embodiment employs as a rotating member a pressure belt which is supported by stretching the pressure belt around three stretching rollers and inside which a pressure pad is placed. The other components of the third exemplary embodiment are similar to those of the first exemplary embodiment, and, therefore, are not described.

As illustrated in FIG. 10, the components on the fixing belt module 61 side of a fixing apparatus 9B according to the third exemplary embodiment are similar to those of the first exemplary embodiment. Thus, in FIG. 10, the components on the fixing belt module 61 side are designated by the same numerals as those in FIGS. 6A and 6B, and redundant description is omitted. The swinging members 68 and the spring member 65 in FIGS. 6A and 6B are not illustrated. In the following, the pressure belt side, which is different from the first exemplary embodiment, is mainly described.

In the fixing apparatus 9B, on the side of pressing the fixing roller 611, a pressure belt 80 is provided so as to be rotationally movable to nip and convey, between the pressure belt 80 and the fixing belt 610, a sheet P onto which a toner image has been transferred. The pressure belt 80 is supported by the pressure belt 80 stretched around a pressure roller 62, a heating roller 82, and a steering roller 81, and is driven to rotate by the fixing belt 610.

The pressure roller 62 is placed to stretch the pressure belt 80 and also to press the fixing roller 611. The steering roller 81 stretches the pressure belt 80 and is also tilted in real time by a control unit (not illustrated) to cancel out the one-sided movement of the pressure belt 80. The heating roller 82, within which a lamp heater is provided, stretches and heats the pressure belt 80. A pressure pad 83 having an elastic layer is provided on the inner peripheral surface side of the pressure belt 80. The elastic layer of the pressure pad 83 presses the fixing roller 611 via the pressure belt 80 and the fixing belt 610.

A nip portion N for the sheet P is formed in the area where the fixing belt 610 is in contact with the pressure belt 80 (the area from the pressure contact portion of the pressure roller 62 and the fixing roller 611 to the pressure contact portion of the pressure pad 83 and the fixing roller 611). The sheet P onto which a toner image has been transferred is introduced into the nip portion N and is heated and pressed to fix the image onto the front surface of the sheet P.

Also in the third exemplary embodiment, similarly to the first exemplary embodiment, the separation pad 64 is swingably provided so as to be likely to bite into the pressure roller 62. Thus, it is unlikely to form a serious pressure reduction portion in the boundary region between the pressure roller 62 and the fixing roller 611. This enables the suppression of image disturbance due to the expansion of air and the generation of water vapor in the nip portion N.

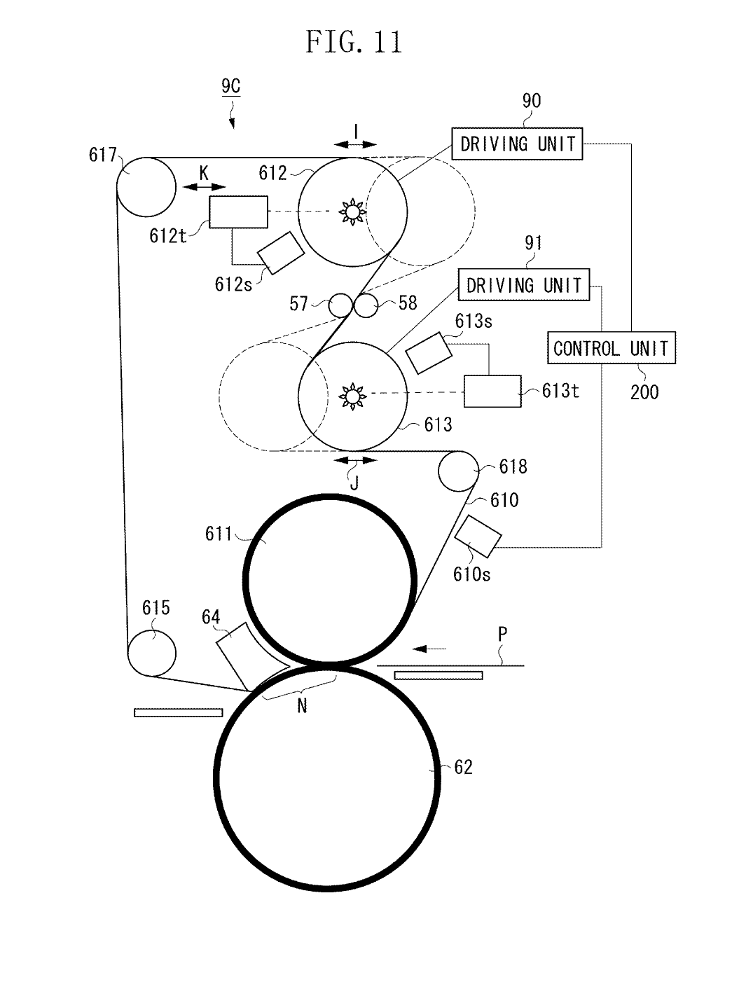

FIG. 11 is a diagram illustrating the configuration of a fixing apparatus according to a fourth exemplary embodiment. As illustrated in FIG. 11, in the fourth exemplary embodiment, to adjust the temperature of a fixing belt 610, the fixing belt 610 is rotatably supported, and at least one of heating rollers for heating the fixing belt 610 is movable. Specifically, it is possible to adjust angles 0 of the fixing belt 610 winding around an internal heating roller 612 and an external heating roller 613. The other components of the fourth exemplary embodiment are similar to those of the first exemplary embodiment, and, therefore, are not described.

The internal heating roller 612 feeds back the temperature detected by a non-contact thermistor 612s, so that a temperature control unit 612t adjusts the temperature of the internal heating roller 612 to a predetermined temperature. The internal heating roller 612 is placed downstream of a stretching roller 615 and upstream of a fixing roller 611 in the rotational direction of the fixing belt 610, and heats the inner surface of the fixing belt 610.

The external heating roller 613 feeds back the temperature detected by a non-contact thermistor 613s, so that a temperature control unit 613t adjusts the temperature of the external heating roller 613 to a predetermined temperature. The external heating roller 613 is placed downstream of the internal heating roller 612 and upstream of the fixing roller 611 in the rotational direction of the fixing belt 610, and heats the outer surface of the fixing belt 610.

Driving units 90 and 91, which are a heating roller moving mechanism, are operated by a control unit 200 as a result of feeding back the temperature detected by a non-contact thermistor 610s. The driving units 90 and 91 can change, between a stretching roller 617 and a stretching roller 618, the length of the portion of the fixing belt 610 winding around the internal heating roller 612 and the length of the portion of the fixing belt 610 winding around the external heating roller 613.

Also the fourth exemplary embodiment having such a configuration can produce effects similar to those of the first exemplary embodiment.

The fixing apparatus according to the present invention has been described above, taking the first to fourth exemplary embodiments as examples, but can be changed to the following configurations.

For example, a heating mechanism for heating the fixing belt 610 may be not only a halogen heater, but also a heating mechanism such as an induction heating mechanism. Further, a fixing apparatus may be not only an apparatus that heats and presses an unfixed toner image formed on a sheet to fix the image, but also an apparatus that heats and presses again a toner image fixed on a sheet to adjust the gloss of the image. Various configurations can thus be replaced by other configurations within the scope of the idea of the present invention, unless otherwise stated.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-091974 filed Apr. 13, 2012, which is hereby incorporated by reference herein in its entirety.

What is claimed is:

1. A fixing apparatus comprising:
a fixing belt configured to fix a toner image on a sheet at a nip portion;
a rotating member configured to convey the sheet cooperatively with the fixing belt at the nip portion;
a supporting roller configured to rotatably support the fixing belt and to press the fixing belt toward the rotating member;
a separation pad provided in a position which is downstream of the supporting roller in a sheet conveyance direction and configured to press the fixing belt toward the rotating member to separate the sheet from the fixing belt;
a holder configured to hold the separation pad, the holder being swingable around a center which is further away from the rotating member than the nip portion and which is downstream of the supporting roller; and
an urging member configured to urge the holder in a rotational direction of the fixing belt.

2. The fixing apparatus according to claim 1, wherein the swinging center of the holder is located in an area surrounded by a tangent line of a nip portion formed between the fixing belt and the rotating member by the supporting roller pressing the fixing belt and the rotating member and a line perpendicular to a tangent line of a nip portion formed between the fixing belt and the rotating member by the separation pad pressing the fixing belt and the rotating member.

3. The fixing apparatus according to claim 1, wherein the swinging center of the holder is located in an area surrounded by a tangent line of a nip portion formed between the fixing belt and the rotating member by the supporting roller pressing the fixing belt and the rotating member and a line connecting a center of gravity of the holder and a position which is a center, in the sheet conveyance direction, of a contact area of the separation pad and the fixing belt.

4. The fixing apparatus according to claim 1, wherein the urging member urges the holder such that a transition from a state where the fixing belt stops rotating to a state where the fixing belt rotates increases a force of the separation pad pressing the fixing belt.

5. The fixing apparatus according to claim 1, further comprising a roller configured to rotatably support the fixing belt,
wherein the holder is swingably supported by the roller.

6. The fixing apparatus according to claim 1, further comprising an adjustment mechanism configured to adjust a position of fixing the separation pad to the holder.

7. The fixing apparatus according to claim 1, further comprising:
a heating roller configured to rotatably support the fixing belt and to heat the fixing belt; and
a changing mechanism configured to change an angle of the fixing belt winding around the heating roller.

8. The fixing apparatus according to claim 1, further comprising a moving mechanism configured to move the rotating member between a first position in contact with the fixing belt and a second position separate from the fixing belt,
wherein the moving mechanism moves the rotating member to the first position according to an entry of the sheet into the fixing apparatus.

9. The fixing apparatus according to claim 1, wherein the rotating member includes a roller.

10. A fixing apparatus comprising:
a fixing belt configured to fix a toner image on a sheet at a nip portion;
a rotating member configured to convey the sheet cooperatively with the fixing belt at the nip portion;
a supporting roller configured to rotatably support the fixing belt and to press the fixing belt toward the rotating member;
a separation pad provided in a position which is downstream of the supporting roller in a sheet conveyance direction and configured to press the fixing belt toward the rotating member to separate the sheet from the fixing belt;
a holder configured to hold the separation pad, the holder being swingable around a center which is further away from the rotating member than the nip portion and which is downstream of the supporting roller; and
an urging member configured to urge the holder,
wherein a direction of a rotational force acting on the holder by the urging member is the same as a direction of a rotational force acting on the holder by the separation pad and the fixing belt sliding in contact with each other.
